(19) United States
(12) Patent Application Publication
(10) Pub. No.: US 2024/0194893 A1
(43) Pub. Date: Jun. 13, 2024

(54) THREE-DIMENSIONAL POROUS CURRENT COLLECTOR WITH INTERNAL VOLUME FOR ACTIVE MATERIAL PARTICLES

(71) Applicant: GM GLOBAL TECHNOLOGY OPERATIONS LLC, Detroit, MI (US)

(72) Inventor: Julia Ruth Klein, Columbus, OH (US)

(73) Assignee: GM GLOBAL TECHNOLOGY OPERATIONS LLC, Detroit, MI (US)

(21) Appl. No.: 18/079,945

(22) Filed: Dec. 13, 2022

(51) Int. Cl. H01M 4/80; H01M 4/04; H01M 4/62; H01M 4/66; H01M 10/0525

(52) U.S. Cl. CPC H01M 4/808; H01M 4/045; H01M 4/622; H01M 4/661; H01M 10/0525

(57) ABSTRACT

An electrode for a rechargeable battery cell includes an electrode substrate. The electrode also includes a current collector fixed to the electrode substrate and having a three-dimensional (3D) porous structure defining void spaces. The electrode additionally includes active material particles arranged within the void spaces. Charging the battery cell reversibly deposits transient ions onto the active material particles and expands the active material particles into the void spaces of the 3D porous structure and discharging the battery cell extracts the transient ions from the active material particles, such that the active material contracts out of the void spaces of the 3D porous structure. A method of manufacturing such an electrode for a rechargeable battery cell is also considered.

### INTRODUCTION

The present disclosure relates to a three-dimensional porous current collector with internal volume for accommodating active material particles, an electrode incorporating such a current collector, and a method of fabricating the same.

Electrochemical energy storage devices, such as lithium-ion batteries, may be used to power such diverse items as toys, consumer electronics, and motor vehicles. Typically, a battery includes two electrodes, as well as an electrolyte component and/or a separator. One of the two electrodes generally serves as a positive electrode or cathode, and the other electrode serves as a negative electrode or anode. Electrochemical battery cells may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused.

Rechargeable batteries may be in a solid form, a liquid form, or a solid-liquid hybrid. A separator and/or electrolyte may be disposed between the negative and positive electrodes. In rechargeable lithium-ion batteries, the electrolyte is typically employed for conducting lithium ions between the electrodes. Generally, lithium-ion batteries operate by reversibly passing lithium ions back and forth between the negative electrode and the positive electrode. For example, lithium ions may move from the positive electrode to the negative electrode during charging of the battery and in the opposite direction when the battery is discharging. Ability of battery electrodes to repeatedly insert into their respective structures and extract therefrom lithium ions is determinative of practical long-term charging capacity of the battery cell.

### SUMMARY

An electrode for a rechargeable battery cell includes an electrode substrate. The electrode also includes a current collector fixed to the electrode substrate and having a three-dimensional (3D) porous structure defining void spaces. The electrode additionally includes active material particles arranged within the void spaces. Charging the battery cell reversibly deposits transient (such as lithium) ions onto the active material particles and expands (or swells) the active material particles into the void spaces of the 3D porous structure. On the other hand, discharging the battery cell extracts the transient ions from the active material particles, such that the active material contracts out of the void spaces of the 3D porous structure.

The current collector may be fixed or applied to the electrode substrate by electrodeposition.

The electrode substrate may be configured as a metal foil. Additionally, each of the electrode substrate and the current collector may be constructed or composed from copper.

The current collector may be coated with an interface layer configured to attract and/or attach to the active material particles.

The current collector may be coated with at least one of a conductivity additive and a polymer binder. In such an embodiment, the binder may be subsequently cured.

The current collector may be pre-coated with the active material particles. In such an embodiment, the pre-coat active material particles may be provided in either a wet carbon-silicon electrode slurry, solid particles, a polymer coating mixed with silicon particles, or a solid lithium form.

The 3D porous structure may include nodes established by pore walls. The pore walls may define the void spaces such that the 3D porous structure has a variable size porosity.

The 3D porous structure may be characterized by a porosity gradient defined by the pore walls gradually increasing in thickness with increasing proximity to the electrode substrate. The subject porosity gradient may be specifically configured to support comparatively higher energy density loading proximate the electrode substrate.

The pore walls may include a coating applied thereto and having a constant thickness.

Alternatively, the pore walls may include a coating applied thereto and having a varying thickness.

The void spaces may be prefilled with a solid, a polymer, and/or a liquid electrolyte.

At least some of the void spaces and corresponding void volume may be generated by removing excess active material particles from the current collector. Such removal of excess active material particles may be accomplished inside a vacuum drum, via blowing through the 3D porous structure with gas jets, or on a vibration table.

The electrode may be subjected to a final cure to hold the active material particles in place within the 3D porous structure and/or evaporate low temperature material.

A method of manufacturing such an electrode having the 3D porous structure current collector for a rechargeable, e.g., lithium-ion, battery cell is also considered.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic view of an electrical energy storage cell powering a load, the energy storage cell being shown as a lithium-ion (Li-Ion) battery relative to three-dimensional (X-Y-Z) space, having respective positive and negative cell electrodes, according to the disclosure.

FIG. 2A is a schematic close-up cross-sectional side view of a representative electrode, shown in FIG. 1, having a current collector fixed to an electrode substrate, wherein the current collector has a three-dimensional (3D) porous structure, according to one embodiment of the disclosure.

FIG. 2B is a schematic close-up cross-sectional side view of a base, prior to various coating layers, current collector for the electrode shown in FIG. 2A, depicted as having variable porosity, according to the disclosure.

FIG. 3A is a schematic close-up cross-sectional side view of a representative electrode, shown in FIG. 1, having a current collector fixed to an electrode substrate, wherein the current collector has a three-dimensional (3D) porous structure, according to another embodiment of the disclosure.

FIG. 3B is a schematic close-up cross-sectional side view of a base, prior to various coating layers, current collector for the electrode shown in FIG. 3A, depicted as having constant porosity, according to the disclosure.

FIG. 4A is a schematic close-up top view of the 3D porous structure coated with an interface layer, as well as with a conductivity additive and/or a polymer binder, and with active material particles embedded within the porous structure, according to the disclosure.

FIG. 4B is a schematic close-up top view of the 3D porous structure coated with an interface layer, as well as with a conductivity additive and/or a polymer binder, and without active material particles embedded within the porous structure, according to the disclosure.

FIG. 5 illustrates a method of manufacturing an electrode for rechargeable battery cell, the electrode including a current collector with a three-dimensional (3D) porous structure shown in FIGS. 1-4B.

FIG. 6A illustrates an embodiment of a process of coating the electrode as part of the method illustrated in FIG. 5.

FIG. 6B illustrates another embodiment of a process of coating the electrode as part of the method illustrated in FIG. 5.

FIG. 6C illustrates a further development of the embodiment illustrated in FIG. 6B.

FIG. 6D illustrates another embodiment of a process of coating the electrode as part of the method illustrated in FIG. 5.

FIG. 6E illustrates a further development of the embodiment illustrated in FIG. 6D.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

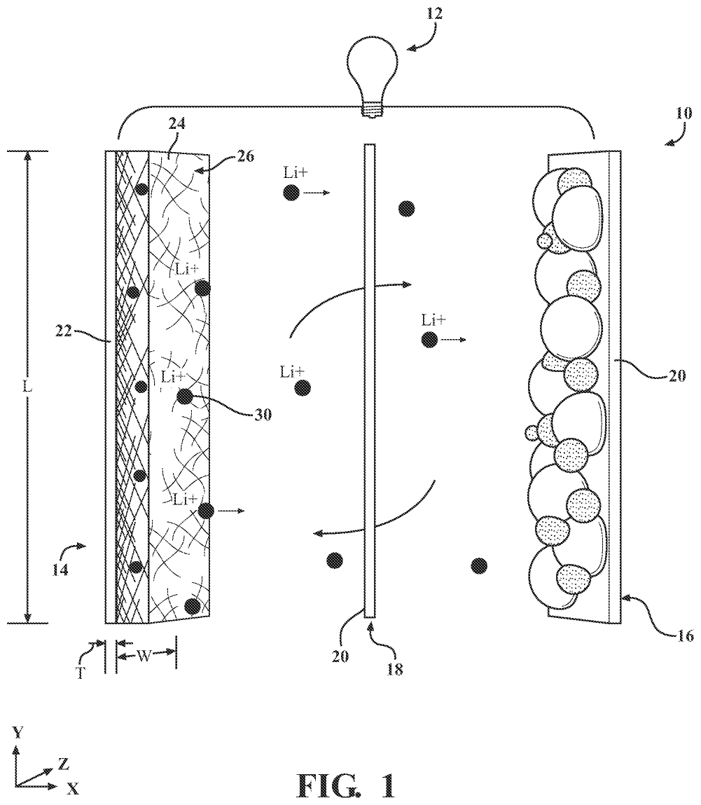

Referring to FIG. 1, an electrical energy storage cell 10 powering a load 12 is depicted. As shown, the electrical energy storage cell 10 has an anode (negative electrode) 14, a cathode (positive electrode) 16, and one of a solid, liquid, gel, and polymer non-aqueous, e.g., polymer-based, electrolyte 18 surrounding the anode, cathode, and saturating a separator diaphragm 20. The storage cell 10 is specifically shown as a lithium-ion (Li-Ion) battery. The anode 14 may be constructed from lithium, graphite, silicon, silicon oxide and various other suitable material. While the cathode 16 is frequently constructed from Li ion battery cathode material, such as lithium manganese oxide, lithium iron phosphate, lithium nickel/manganese/cobalt oxide, or a variety of other suitable materials, may also be used.

Li-Ion batteries are rechargeable electrochemical batteries notable for their high specific energy and low self-discharge. The Li-Ion batteries may be used to power such diverse items as toys, consumer electronics, and motor vehicles. Although the electrical energy storage cell 10 is specifically shown as a Li-Ion battery, broadly considered, other battery chemistries and corresponding structures are also envisioned. The subject vehicle may include, but not be limited to, a commercial vehicle, industrial vehicle, passenger vehicle, aircraft, watercraft, train or the like. It is also contemplated that the vehicle may be a mobile platform, such as an airplane, all-terrain vehicle (ATV), boat, personal movement apparatus, robot and the like to accomplish the purposes of the present disclosure.

In Li-Ion batteries, lithium ions move from the anode 14 through the electrolyte 18 to the cathode 16 during discharge, and back when charging. Li-Ion batteries use a lithium metal oxide, such as Li-NMC, Li-NMCA, LMO, NMO, LFP etc., as the material at the positive electrode and typically graphite at the negative electrode. Generally, the reactants in the electrochemical reactions in a Li-Ion cell 10 are materials of anode and cathode, both of which are compounds that may host lithium atoms. During discharge, an oxidation half-reaction at the anode 14 produces positively charged lithium ions and negatively charged electrons. Lithium ions move through the electrolyte 18, electrons move through an external circuit (including a connection to the electrical load 12 or to a charging device), and then they recombine at the cathode (together with the cathode material) in a reduction half-reaction.

The electrolyte 18 and the external circuit provide conductive media for lithium ions and electrons, respectively, but do not partake in the electrochemical reaction. Generally, during discharge of an electrochemical battery cell, electrons flow between the electrodes, from the anode 14 toward the cathode 16, through the external circuit. The reactions during discharge lower the chemical potential of the cell, so discharging transfers energy from the cell to wherever the electric current dissipates its energy, mostly in the external circuit. During charging, the described reactions and transports go in the opposite direction: electrons move from the positive electrode to the negative electrode through the external circuit. To charge the cell, the external circuit has to provide electric energy. This energy is then stored (with some loss) as chemical energy in the cell.

In a Li-Ion cell, both the anode 14 and cathode 16 allow lithium ions to move in and out of their structures via a process called insertion (intercalation) or extraction (deintercalation), respectively. Typically, the anode 14 employs a current collector, which may be manufactured from copper and include an active layer configured to intercalate lithium ions. Generally, while the amount of lithium held by the active layer is directly related to the performance of a Li-Ion battery. Furthermore, the capacity of the active layer to intercalate lithium is limited by its physical or the material's molecular structure. Accordingly, an increase in the amount of lithium held by the electrode, such as the anode 14, would be beneficial to the performance, e.g., cycling capacity, of a Li-Ion battery cell 10.

A specific construction of the electrode for a lithium-ion battery cell 10, such as the anode 14 (or the cathode 16), is configured to maximize an amount of lithium held thereby during charging and discharging. Particularly in the case of an anode, during charging lithium bonds to silicon, which leads to significant swelling of the silicon. The subject construction of the electrode, to be described in detail below, is specifically configured to accommodate the silicon swelling during charging and also permit transport of lithium ions in and out of the electrode structure following the swelling. The subject electrode includes an electrode substrate 22, which may be constructed from a section of metal foil (generally identified as a current collector foil) defined by thickness T, a width W, and a length L. The electrode also includes a current collector 24 fixed to, such as adhered or formed on, the electrode substrate 22. The current collector 24 may be fixed to the electrode substrate 22 by a process of electroplating, electrochemical deposition, physical deposition, or welding. Specifically, material of the current collector 24 may be electrochemically deposited onto a surface of the electrode substrate 22 to generate the subject battery cell 10 electrode. Each of the electrode substrate 22 the current collector 24 may be composed of or constructed from copper.

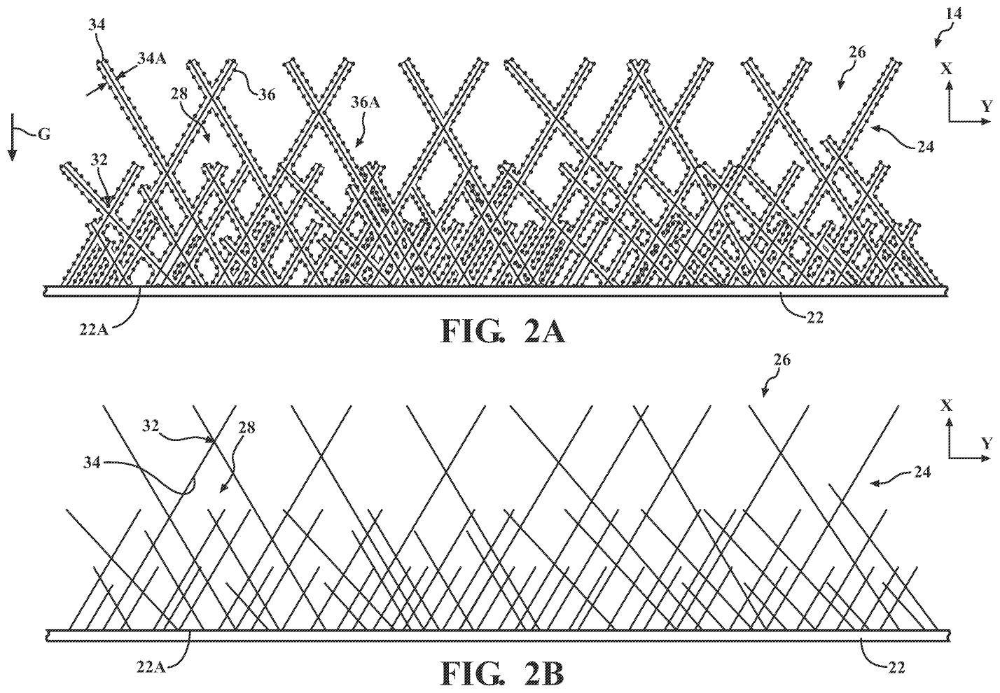

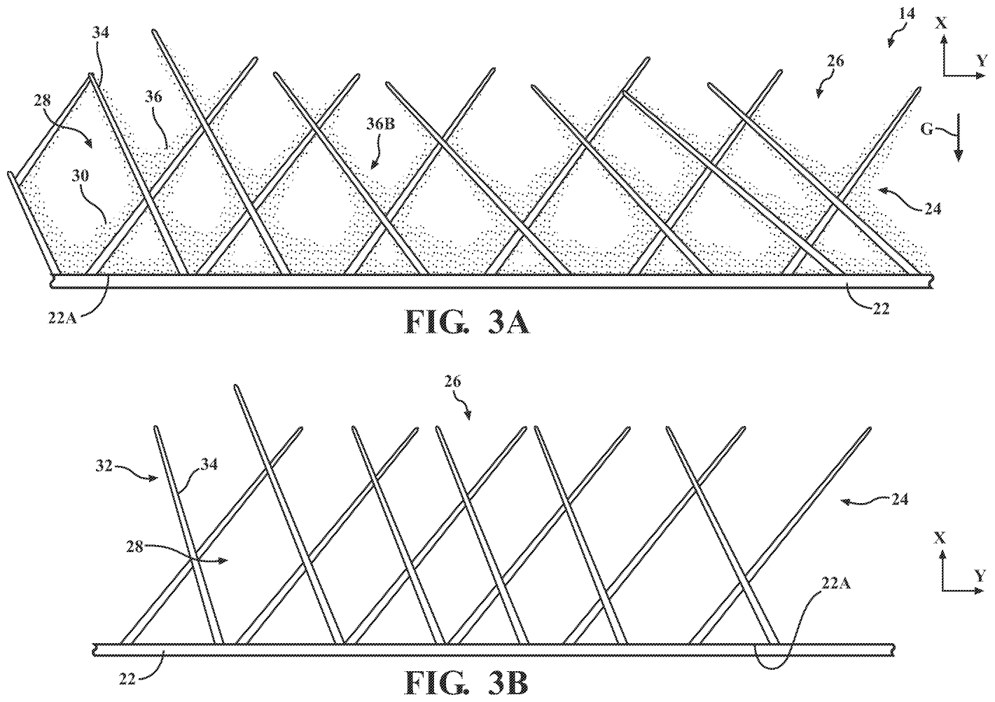

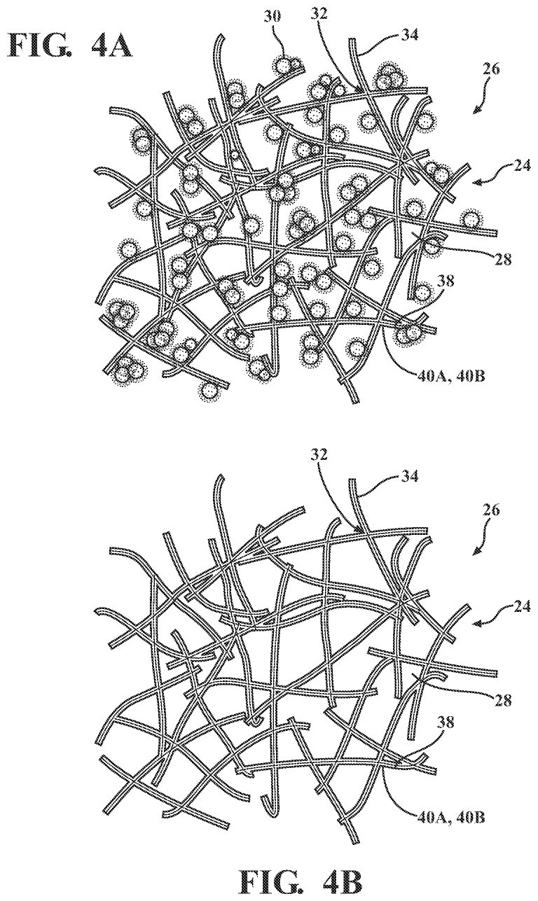

As shown in FIGS. 2-4B, the resultant current collector 24 applied onto the electrode substrate 22 has a three-dimensional (3D) porous structure 26 defining multiple interstitial void spaces 28 (shown in FIGS. 3-4B) generated, for example, by contacting, crisscrossing, and/or interwoven fibers. The current collector 24 may, for example, and as shown in FIG. 1, provide an anode 14 structure. The void spaces 28 are configured to accommodate therein active material particles 30, e.g., of a lithium-alloy material. Additionally, prior to initial charging of the battery cell 10, the void spaces 28 may be prefilled and/or covered with the polymer, gel, or glass/ceramic electrolyte 18. Specifically, while the void spaces 28 are generally left open and not filled, they may be prefilled with a gel or soft polymer electrolyte 18. Additionally, a top surface of the current collector 24 may be covered with a polymer or solid glass/ceramic electrolyte 18 to seal the subject surface of the current collector relative to the separator 20.

The term “3D porous” is herein used to indicate a current collector structure that includes porosity having a varying or uneven size in three-dimensional space, such as in a direction orthogonal to a mounting surface 22A of the electrode substrate 22. The 3D porous structure 26 may also be designated as “porosity-controlled”, which herein denotes a collector body having a particularly defined distribution of variable porosity and non-uniform magnitude of included pores. A specific distribution of variable porosity in the 3D porous structure 26 is intended to facilitate effective internal rather than external expansion volume of the current collector 24 for intercalated active material particles 30 during charging of the battery cell 10.

As shown in FIG. 2, the 3D porous structure 26 may include nodes 32 established by pore walls 34. The pore walls 34 define the void spaces 28. The 3D porous structure 26 may further have a variable size porosity, i.e., the void spaces 28 may have a variable size. The 3D porous structure 26 may be further characterized by a porosity gradient G defined by the pore walls 34 gradually increasing in thickness 34A with greater proximity to the electrode substrate 22. An electrodeposited attachment layer or vapor deposition attachment may be added to fibers initially unconnected to each other, thereby generating intersectional nodes 32. The nodes 32 may also increase in thickness with greater proximity to the mounting surface 22A of the electrode substrate 22 to carry higher electrical current. Accordingly, the subject gradient G may be purposefully configured to support comparatively higher energy density loading during charging of the battery cell 10 on the current collector 24 proximate the electrode substrate 22 (relative to density loading closer to the outer surface of the current collector).

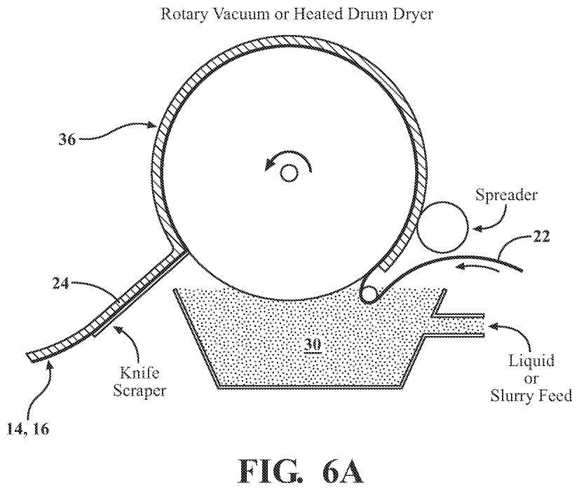

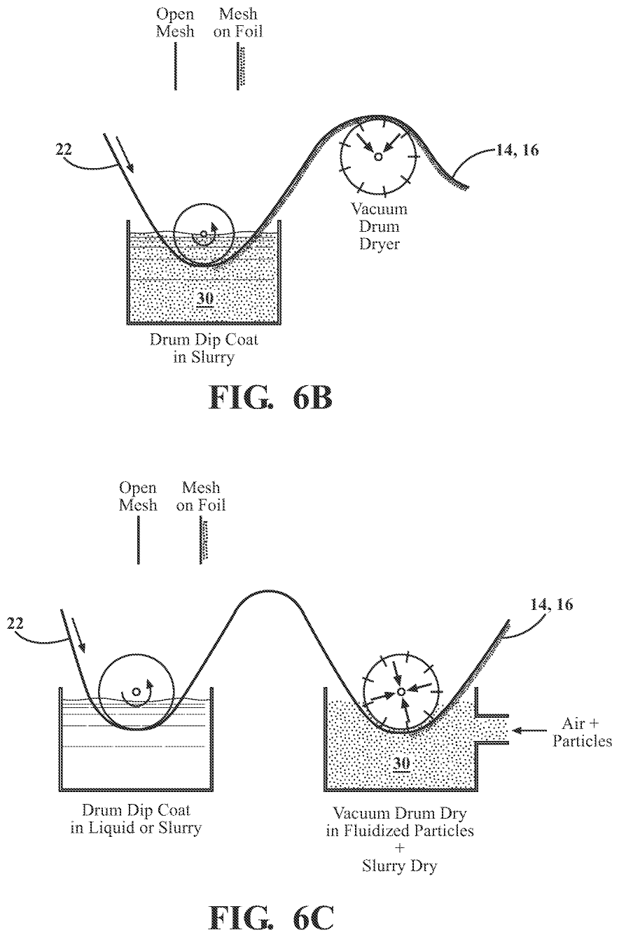

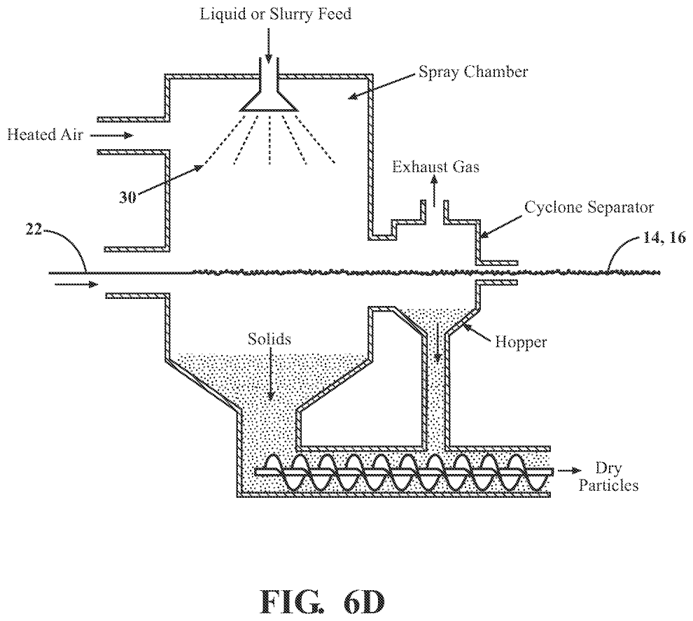

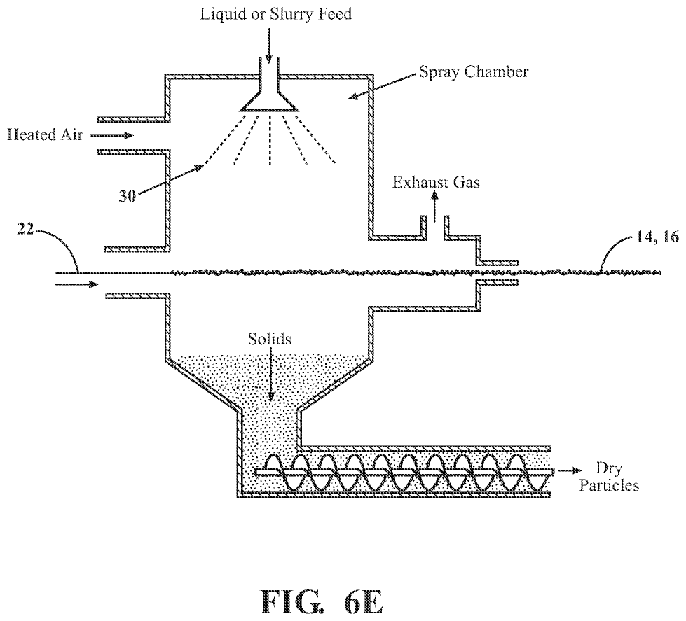

The pore walls 34 may include a coating 36 applied thereto. The coating 36 may be applied via polymer coating or particle coating and in certain embodiments be configured to generate the gradient G. Polymer coating and particle coating may be affected by a variety of options, shown in exemplary fashion in FIGS. 6A-6E, such as dip coating and drum drying, spray coating, slurry coating with a slot die, roll coating in wet/dry particle bed, fluidized air particle bed, thermal (vapor) deposition, vacuum drum coating and drying (filtration). Specifically, the coating 36 may include one or more layers of a binder or adhesive configured to affix the active material particles 30 to the pore walls 34. As shown in FIG. 2A, the coating 36 may have a constant thickness 36A in an embodiment where porosity of the base current collector 24 is variable (shown in FIG. 2B). Alternatively, as shown in FIG. 3A, the coating 36 may have a varying thickness 36B in an embodiment where porosity of the base current collector 24 is constant (shown in FIG. 3B). Accordingly, as may be seen in FIGS. 2A and 3A, in either embodiment, the resultant 3D porous structure 26 will have the size of the void spaces 28 progressively increasing with further distance from the electrode substrate 22, thereby defining the gradient G.

The active material particles 30 will be applied to the 3D porous structure 26 as a coating, such that the active material particles become arranged and dispersed within the void spaces 28 of the 3D porous structure. As a result, charging of the battery cell 10 employing the subject electrode reversibly deposits transient (such as lithium) ions onto the active material particles 30 and expands (or swells) the active material particles into the void spaces 28 of the 3D porous structure 26, thereby generating an interstitial active material current collector structure. On the other hand, discharging the battery cell 10 employing the subject electrode extracts the transient ions from the active material particles 30, such that the active material contracts out of the void spaces 28 of the 3D porous structure 26. Accordingly, the battery cell 10 may undergo repeated cycles of intercalation and deintercalation of lithium ions in the process of accepting charge from an external energy source, such as electrical grid, and then supply the charge to power the load 12.

Each of FIGS. 4A and 4B depict a top view of the 3D porous structure 26, respectively with and without the active material particles 30 embedded therein. As shown in FIGS. 4A and 4B, the current collector 24 may be coated with an interface layer 38 configured to attract and/or attach to the active material particles 30. Additionally, the current collector 24 may be coated with a conductivity additive 40A and/or an elastic polymer binder 40B. In the embodiment where the current collector 24 is coated with the polymer binder 40B, the binder may then be cured, polymerized, carbonized and/or graphitized, such as in a vacuum, an oven, and/or with infrared or ultraviolet light. The current collector 24 may be pre-coated with the active material particles 30. In such an embodiment, the pre-coat active material particles 30 may be provided either in wet carbon-silicon electrode slurry, solid particles, a polymer coating mixed with silicon particles, or a solid lithium form. The pre-coat may be employed to “prelithiate”, i.e., effectively pre-charge, the lithium-ion battery anode 14 and mitigate non-recoverable loss of lithium during initial cycling of the battery cell 10 and increase overall cycle capacity of the battery cell.

The electrode embodying the 3D porous structure 26 may be subjected to a final cure to hold active material particles 30 in place, and also to evaporate low temperature material, such as from the carbon-silicon slurry. Manufacturing of the current collector 24 may also include removal of excess active material particles 30 from the current collector 24. Such removal of excess active material particles 30 may be accomplished by running the current collector 24 externally over a vacuum drum, via blowing through the 3D porous structure 26 with a pressurized gas stream, or by agitating the current collector 24 on a vibration table. The completed current collector 24 is intended to provide the 3D porous structure 26 capable of accommodating an increased volume of intercalated active material as compared to a current collector (with a similar external surface area) having consistently sized pores or a non-porous structure.

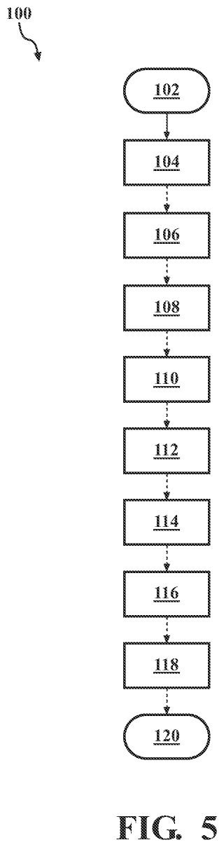

A method 100 of manufacturing a component the electrode, such as the anode 14 or the cathode 16 for a rechargeable battery cell 10 is depicted in FIG. 5 and disclosed in detail below. Method 100 is generally intended for generating the three-dimensional (3D) porous structure 26 of the current collector 24, as described above with respect to FIGS. 1-4B. Method 100 commences in frame 102 with providing and setting up the electrode substrate 22, such as constructed from a copper foil, on a manufacturing surface, e.g., a tooling or fixturing plate. Following frame 102, the method advances to frame 104. In frame 104, the method includes fixing the current collector 24 having the 3D porous structure 26 to the electrode substrate 22. For example, the current collector 24 may be composed of copper and fixed to the electrode substrate 22 by electrochemical deposition.

From frame 104, after the generation of the 3D porous structure 26, the method may proceed to frame 106. In frame 106, the method includes applying the coating 36 to the pore walls 34 such as by a dip or spray process. As described above, the coating 36 may have constant thickness 36A where the base porosity of the 3D porous structure 26 is variable and, alternatively, have varying thickness 36B where the base porosity is constant. From frame 106, the method may proceed to frame. In frame 108, the method includes coating the current collector 24 with the interface layer 38 configured to attract and/or attach to the active material particles 30. From frame 108 the method may advance to frame 110.

In frame 110, the method includes pre-coating the 3D porous structure 26 of the current collector 24 with wet or dry active material particles 30, such as by dip coating, spraying on, or using a fluidized process to thereby arrange the active material particles within the void spaces 28. As described with respect to FIGS. 1-4B, the void spaces 28 of the resultant 3D porous structure 26 are configured to accommodate therein active material particles 30. The 3D porous structure 26 may be characterized by the porosity gradient G, as described above with respect to FIGS. 1-4B, to support comparatively higher energy density loading proximate the electrode substrate 22, as compared with energy density on the distal surface of the 3D porous structure.

Following frame 110 the method may advance to frame 112 for removing excess active material particles 30 from the current collector 24, such as in a vacuum drum or via a gas spray. From frame 112, the method may move on to frame 114. In frame 114, the method includes additionally coating the current collector 24 with at least one of a conductivity additive (and/or carbon protective layer) 40A and the elastic polymer binder 40B, such as by a dip or a spray process. After frame 114, the method may advance to frame 116, where the method includes curing the binder 40B, such as in a vacuum, an oven, and/or with infrared or ultraviolet light. Following each of frame 118, the method may proceed to incorporation of the completed electrode into the battery cell 10 or conclude in frame 120.

As illustrated in FIGS. 6A-6E and described above, the method may include polymer and/or particle coating of the current collector 24 using a variety of operations using specific equipment. Specifically, as shown in FIG. 6A, the electrode substrate 22 with the affixed current collector 24 having the 3D porous structure 26 may be dip coated in a wet/dry, liquid or slurry, active material particle 30 bed. The adhered active material particles 30 may be spread or roll coated onto the current collector 24, drum dried, and the completed electrode 14 or 16 may then be separated from the drum via a knife scraper. As shown in FIG. 6B, the current collector 24 may be drum dip coated in a liquid or slurry of active material particles 30 and vacuum drum dried. The current collector 24 may also be drum dip coated in liquid or slurry of active material particles 30 and then be additionally coated using a fluidized air active material particle bed and air dried (shown in FIG. 6C) to complete the electrode 14 or 16.

As shown in FIGS. 6D and 6E, the current collector 24 may be liquid or slurry coated via thermal (vapor) deposition in a spray chamber. The coating process may involve introducing heated air into a spray chamber during the liquid or slurry feed. The electrode substrate 22 with the affixed current collector 24 having the 3D porous structure 26 is then passed through the spray chamber for coating with the active material particles 30. Solid active material particles 30 that did not lodge within the 3D porous structure 26 may be pulled away via a cyclone separator, collected via a hopper (shown in FIG. 6D), and removed using a screw conveyor. In some embodiments, as shown in FIG. 6E, the process may be effective without the use of a cyclone separator. Gas remaining in the spray chamber following the coating process may be removed via an exhaust or chimney.

When the resultant electrode is employed in the battery cell 10, charging of the battery cell 10 reversibly expands or swells the active material particles 30 into the void spaces 28 of the 3D porous structure 26. Conversely, discharging of the battery cell 10 contracts the active material particles 30 out of the void spaces 28 of the 3D porous structure 26. The 3D porous structure 26 generated by the method 100 may permit the current collector 24 to support a greater energy density loading via accommodating a greater volume of the active material particles 30 within the void spaces 28 as compared to a structure having constant sized pores. Consequently, such increased energy density loading of the 3D porous structure 26 with a higher concentration of lithium alloy material, such as silicon, than standard Li-Ion batteries enables a greater charging capacity of the battery cell 10.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electrode for a rechargeable battery cell, comprising:
an electrode substrate; and
a current collector fixed to the electrode substrate and having a three-dimensional (3D) porous structure defining void spaces; and
active material particles arranged within the void spaces;
wherein charging the battery cell reversibly deposits transient ions onto the active material particles and expands the active material particles into the void spaces of the 3D porous structure and discharging the battery cell extracts the transient ions from the active material particles, such that the active material contracts out of the void spaces of the 3D porous structure.

2. The electrode according to claim 1, wherein the current collector is fixed to the electrode substrate by electrochemical deposition.

3. The electrode according to claim 1, wherein the electrode substrate is configured as a metal foil, and wherein each of the electrode substrate and the current collector is constructed from copper.

4. The electrode according to claim 1, wherein the current collector is coated with an interface layer configured to at least one of attract and attach to the active material particles.

5. The electrode according to claim 1, wherein the current collector is coated with at least one of a conductivity additive and a polymer binder.

6. The electrode according to claim 1, wherein the current collector is pre-coated with the active material particles and the pre-coat active material particles are provided in one of a wet carbon-silicon electrode slurry, solid particles, a polymer coating mixed with silicon particles, or a solid lithium form.

7. The electrode according to claim 1, wherein the 3D porous structure includes nodes established by pore walls defining the void spaces and the 3D porous structure has a variable size porosity.

8. The electrode according to claim 7, wherein the 3D porous structure is characterized by a porosity gradient defined by the pore walls gradually increasing in thickness with increasing proximity to the electrode substrate and thereby configured to support comparatively higher energy density loading proximate the electrode substrate.

9. The electrode according to claim 8, wherein the pore walls include a coating applied thereto and having a constant thickness.

10. The electrode according to claim 8, wherein the pore walls include a coating applied thereto and having a varying thickness.

11. A method of manufacturing an electrode for a rechargeable battery cell, the method comprising:
providing an electrode substrate; and
fixing a current to the electrode substrate, wherein the collector has a three-dimensional (3D) porous structure defining void spaces configured to accommodate therein active material particles; and
arranging active material particles within the void spaces;
wherein charging the battery cell reversibly deposits transient ions onto the active material particles and expands the active material particles into the void spaces of the 3D porous structure and discharging the battery cell extracts the transient ions from the active material particles, such that the active material contracts out of the void spaces of the 3D porous structure.

12. The method of manufacturing an electrode according to claim 11, wherein fixing the current collector to the electrode substrate includes applying the current collector onto the electrode substrate by electrochemical deposition.

13. The method of manufacturing an electrode according to claim 11, wherein the electrode substrate is configured as a metal foil, and wherein providing the electrode substrate and the current collector includes constructing each of the electrode substrate and the current collector from copper.

14. The method of manufacturing an electrode according to claim 11, further comprising coating the current collector with an interface layer configured to at least one of attract and attach to the active material particles.

15. The method of manufacturing an electrode according to claim 11, further comprising coating the current collector with at least one of a conductivity additive and a polymer binder.

16. The method of manufacturing an electrode according to claim 11, further comprising pre-coating the current collector with active material particles, and wherein pre-coat active material particles are provided in one of a wet carbon-silicon electrode slurry, solid particles, a polymer coating mixed with silicon particles, or a solid lithium form.

17. The method of manufacturing an electrode according to claim 1, wherein the 3D porous structure includes nodes established by pore walls defining the void spaces and the 3D porous structure has a variable size porosity.

18. The method of manufacturing an electrode according to claim 17, wherein the 3D porous structure is characterized by a porosity gradient defined by the pore walls gradually increasing in thickness with increasing proximity to the electrode substrate and thereby configured to support comparatively higher energy density loading proximate the electrode substrate.

19. The method of manufacturing an electrode according to claim 18, further comprising applying to the pore walls a coating having one of a constant thickness and a varying thickness.

20. An electrode for a lithium-ion rechargeable battery cell, comprising:
an anode substrate; and
an anode current collector fixed to the anode substrate and having a three-dimensional (3D) porous structure defining void spaces;
wherein:
the 3D porous structure includes nodes established by pore walls defining the void spaces and the 3D porous structure has a variable size porosity characterized by a porosity gradient defined by the pore walls gradually increasing in thickness with increasing proximity to the anode substrate and thereby configured to support comparatively higher energy density loading proximate the anode substrate; and
active material particles arranged within the void spaces;
wherein charging the battery cell reversibly deposits transient lithium ions onto the active material particles and expands the active material particles into the void spaces of the 3D porous structure and discharging the battery cell extracts the transient lithium ions from the active material particles, such that the active material contracts out of the void spaces of the 3D porous structure.
